(19) United States
(12) Patent Application Publication
(10) Pub. No.: US 2026/0371167 A1
(43) Pub. Date: Nov. 19, 2026

(54) LOAD BALANCING IN NETWORK DEVICE SYSTEM

(71) Applicant: QUALCOMM Incorporated, San Diego, CA (US)

(72) Inventors: Zaiyong CHEN, Shanghai (CN); Nicolas GRAUBE, Cambridge (GB); Jie ZHANG, Shanghai (CN); Cheng JIANG, Shanghai (CN); Zhaoming YANG, Shanghai (CN); Zhuxian GU, Suzhou (CN); Zhengjinyang JIANG, Shanghai (CN); Yibo ZHAO, Shanghai (CN); Liuliu ZHAO, Shanghai (CN); Zixiang WANG, Shenzhen (CN)

(21) Appl. No.: 19/146,880

(22) PCT Filed: Feb. 22, 2023
(86) PCT No.: PCT/CN2023/077551

§ 371 Date: Jul. 9, 2025

(51) Int. Cl. H04W 28/086; H04W 56/00; H04W 76/10; H04W 76/40

(52) U.S. Cl. CPC H04W 28/0861; H04W 56/001; H04W 76/10; H04W 76/40

(57) ABSTRACT

Disclosed are systems and techniques for wireless communications. In one illustrative example, a wireless communication device can receive, from a primary network device, a synchronization message comprising a command to start a connectable advertisement. The wireless communication device can broadcast the connectable advertisement based on receiving the command. The wireless communication device can receive a connection request from a secondary network device and can connect with the secondary network device based on receiving the connection request such that additional connection requests associated with the wireless communication device are offloaded from the primary network device to the secondary network device.

### FIELD OF THE DISCLOSURE

The present disclosure generally relates to wireless communications. For example, aspects of the present disclosure relate to load balancing between network devices (e.g., access points (APs)).

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one example, a wireless communication device for wireless communication is provided. The wireless communication device includes at least one memory and at least one processor coupled to the at least one memory and configured to: receive, from a primary network device, a synchronization message comprising a command to start a connectable advertisement; broadcast the connectable advertisement based on receiving the command; receive a connection request from a secondary network device; and connect with the secondary network device based on receiving the connection request such that additional connection requests associated with the wireless communication device are offloaded from the primary network device to the secondary network device.

In another illustrative example, a method of wireless communication performed at a wireless communication device is provided. The method includes: receiving, by the wireless communication device from a primary network device, a synchronization message comprising a command to start a connectable advertisement; broadcasting, by the wireless communication device, the connectable advertisement based on receiving the command; receiving, by the wireless communication device, a connection request from a secondary network device; and connecting, by the wireless communication device, with the secondary network device based on receiving the connection request such that additional connection requests associated with the wireless communication device are offloaded from the primary network device to the secondary network device.

In another illustrative example, a non-transitory computer-readable medium of a wireless communication device is provided having stored thereon instructions that, when executed by at least one processor, cause the at least one processor to: receive, from a primary network device, a synchronization message comprising a command to start a connectable advertisement; broadcast the connectable advertisement based on receiving the command; receive a connection request from a secondary network device; and connect with the secondary network device based on receiving the connection request such that additional connection requests associated with the wireless communication device are offloaded from the primary network device to the secondary network device.

In another illustrative example, a wireless communication device is provided that includes: means for receiving, from a primary network device, a synchronization message comprising a command to start a connectable advertisement; means for broadcasting the connectable advertisement based on receiving the command; means for receiving a connection request from a secondary network device; and means for connecting with the secondary network device based on receiving the connection request such that additional connection requests associated with the wireless communication device are offloaded from the primary network device to the secondary network device.

In another illustrative example, a wireless communication device for wireless communication is provided. The wireless communication device includes at least one memory and at least one processor coupled to the at least one memory and configured to: receive, from a primary network device, a synchronization message comprising a connection request; transmit, to the primary network device, a connection request response based on receiving the connection request; transmit, to a secondary network device, a response based on receiving the connection request; receive a first data packet for a connection event from the secondary network device; and connect with the secondary network device based on receiving the first data packet for the connection event such that additional connection events associated with the wireless communication device are offloaded from the primary network device to the secondary network device.

In another illustrative example, a method of wireless communication performed at a wireless communication device is provided. The method includes: receiving, by the wireless communication device from a primary network device, a synchronization message comprising a connection request; transmitting, by the wireless communication device to the primary network device, a connection request response based on receiving the connection request; transmitting, by the wireless communication device to a secondary network device, a response based on receiving the connection request; receiving, by the wireless communication device, a first data packet for a connection event from the secondary network device; and connecting, by the wireless communication device, with the secondary network device based on receiving the first data packet for the connection event such that additional connection events associated with the wireless communication device are offloaded from the primary network device to the secondary network device.

In another illustrative example, a non-transitory computer-readable medium of a wireless communication device is provided having stored thereon instructions that, when executed by at least one processor, cause the at least one processor to: receive, from a primary network device, a synchronization message comprising a connection request; transmit, to the primary network device, a connection request response based on receiving the connection request; transmit, to a secondary network device, a response based on receiving the connection request; receive a first data packet for a connection event from the secondary network device; and connect with the secondary network device based on receiving the first data packet for the connection event such that additional connection events associated with the wireless communication device are offloaded from the primary network device to the secondary network device.

In another illustrative example, a wireless communication device is provided that includes: means for receiving, from a primary network device, a synchronization message comprising a connection request; means for transmitting, to the primary network device, a connection request response based on receiving the connection request; means for transmitting, to a secondary network device, a response based on receiving the connection request; means for receiving a first data packet for a connection event from the secondary network device; and means for connecting with the secondary network device based on receiving the first data packet for the connection event such that additional connection events associated with the wireless communication device are offloaded from the primary network device to the secondary network device.

In another illustrative example, a wireless communication device for wireless communication is provided. The wireless communication device includes at least one memory and at least one processor coupled to the at least one memory and configured to: receive, from a secondary network device, a synchronization message comprising a connection request; transmit, to the secondary network device, a response based on receiving the connection request; receive a first data packet for a connection event from the secondary network device; and connect with the secondary network device based on receiving the first data packet for the connection event such that additional connection events associated with the wireless communication device are offloaded from a primary network device to the secondary network device.

In another illustrative example, a method of wireless communication performed at a wireless communication device is provided. The method includes: receiving, by the wireless communication device from a secondary network device, a synchronization message comprising a connection request; transmitting, by the wireless communication device to the secondary network device, a response based on receiving the connection request; receiving, by the wireless communication device, a first data packet for a connection event from the secondary network device; and connecting, by the wireless communication device, with the secondary network device based on receiving the first data packet for the connection event such that additional connection events associated with the wireless communication device are offloaded from a primary network device to the secondary network device.

In another illustrative example, a non-transitory computer-readable medium of a wireless communication device is provided having stored thereon instructions that, when executed by at least one processor, cause the at least one processor to: receive, from a secondary network device, a synchronization message comprising a connection request; transmit, to the secondary network device, a response based on receiving the connection request; receive a first data packet for a connection event from the secondary network device; and connect with the secondary network device based on receiving the first data packet for the connection event such that additional connection events associated with the wireless communication device are offloaded from a primary network device to the secondary network device.

In another illustrative example, a wireless communication device is provided that includes: means for receiving, from a secondary network device, a synchronization message comprising a connection request; means for transmitting, to the secondary network device, a response based on receiving the connection request; means for receiving a first data packet for a connection event from the secondary network device; and means for connecting with the secondary network device based on receiving the first data packet for the connection event such that additional connection events associated with the wireless communication device are offloaded from a primary network device to the secondary network device.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a diagram illustrating an example associated with discovery and synchronization between access points, in accordance with some aspects of the present disclosure.

FIG. 5 is a diagram illustrating examples of areas that are each associated with a respective AP, where the areas overlap to form overlapping areas, in accordance with some aspects of the present disclosure.

FIG. 6A is a diagram illustrating an example of an access protocol having three Asynchronous Connection-Oriented Link (ACL) time slots, in accordance with some aspects of the present disclosure.

FIG. 6B is a diagram illustrating an example of an access protocol having one ACL time slot, in accordance with some aspects of the present disclosure.

FIG. 7 is a diagram illustrating an example of access point offloading utilizing a legacy connection mode, in accordance with some aspects of the present disclosure.

FIG. 8A is a diagram illustrating an example of access point offloading utilizing a fast connection mode, in accordance with some aspects of the present disclosure.

FIG. 8B is a diagram illustrating an example of an access protocol having three ACL time slots, where a secondary access point is scanning for auxiliary (AUX) connection request packet (ACRQ) information, in accordance with some aspects of the present disclosure.

FIG. 8C is a diagram illustrating an example of access point offloading utilizing a simplified fast connection mode, in accordance with some aspects of the present disclosure.

FIG. 9 is a flow chart illustrating an example of a process for wireless communications at a wireless communication device (e.g., an electronic shelf label), in accordance with some aspects of the present disclosure.

FIG. 10 is a flow chart illustrating another example of a process for wireless communications at a wireless communication device (e.g., an electronic shelf label), in accordance with some aspects of the present disclosure.

FIG. 11 is a flow chart illustrating another example of a process for wireless communications at a wireless communication device (e.g., an electronic shelf label), in accordance with some aspects of the present disclosure.

FIG. 12 is a block diagram illustrating an example of a computing system, which may be employed by the disclosed systems and techniques for load balancing between APs, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. The network entity may communicate with the one or more wireless communication devices via one or more network devices. For example, an electronic shelf label (ESL) system may include one or more ESLs that are controlled by a management entity (ME). To facilitate control by the management entity, each ESL may have a wireless connection (e.g., a BLUETOOTH® Low Energy (BLE) connection or other connection) to an access point (AP) that is communicatively connected to the management entity (e.g., via the Internet, such as wirelessly, via an Ethernet connection, etc.). In some cases, commands from the management entity may be wirelessly transmitted to the ESLs by the access point. Responses or information from the ESLs may also be received by the access point and provided by the access point to the management entity. Each access point may have an associated channel map. A channel map is a listing of frequency channels to be utilized or, conversely, not to be utilized (e.g., in the context of modification of frequency hopping sequences) by an access point for communication, such as with the ESLs or other devices. While examples are described herein using ESLs as illustrative examples of wireless communication devices, a management entity as an example of a network entity, and access points as examples of network devices, the systems and techniques described herein are applicable to any type of system or network.

In some cases, an ESL may be physically moved to a new location. For example, the ESL may be moved from one location in a retail store (e.g., a particular shelf or a storage area) to a different location. Changing the location of the ESL may result in the ESL losing synchronization with (e.g., due to being out of range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point. To perform the onboarding procedure, the ESL may transmit advertisement messages, receive a connection request from an in-range access point that detected the advertisement messages, and exchange messages with the access point (e.g., including the exchange of periodic advertisement synchronization transfer (PAST) information). The onboarding procedure may consume significant computing resources (e.g., processor resources, memory resources, and/or battery resources, among other examples) of the ESL and/or the access point, and frequent advertisement by one or more ESLs may result in spectral pollution on advertisement channels of the wireless network.

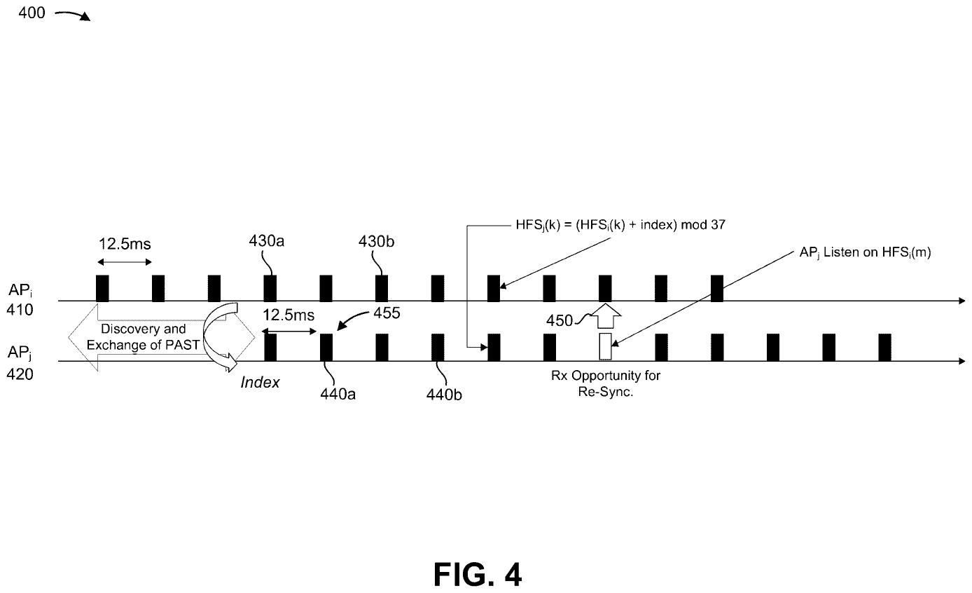

Currently, access point synchronization (e.g., described in detail in the description of FIG. 4) can enable discovery and synchronization of communication timings of multiple access points within an ESL system. In particular, periodic advertisement timings used by the multiple access points may be synchronized.

In access point synchronization, an ESL can have access to multiple access points. When an ESL is moved from one location to another location such that the ESL is out of range of its current associated access point, the ESL can identify an alternative access point that is within range of the ESL to associate with and jump on a periodic advertisement with multiple responses (PAwMR) train associated with that access point. In a typical environment (e.g., a large retail store, a warehouse, etc.), access points may be positioned in various different locations around the environment.

In a well-deployed ESL system within an environment (e.g., a large retail store, a warehouse, etc.), a management entity may manage many access points, where each access point may manage up to seven-thousand (7000) ESLs. Each management entity can have detailed information regarding each access point and each ESL deployed within the environment. During operation of the ESL system, the management entity may support a number of different features including, but not limited to, a wake up of the ESLs, an onboarding of the ESLs, an accessing of the ESLs, a generic attribute profile (GATT) protocol for data transfer, and a “Bulk Transfer” of data with the ESLs.

ESL systems can employ Asynchronous Connection-Oriented Links (ACLs), which are each a data link between an access point and an ESL for the transmission of general data packets over a BLE connection. Generally, each access point within an ESL system can only have up to three (3) concurrent ACLs. When an access point is running three ACLs, that access point is experiencing a heavy loading and, as such, that access point may not be able to handle any additional connection requests from a management entity. For example, the access point may receive the additional connection requests from the management entity, but the additional connection requests will be queued in a pending request queue, since there are already three concurrent ACL links running. Once an ACL link is freed, the access point can handle another new connection request from the pending queue. A load balancing between access points should be performed to increase the connection links capacity and to improve system performance.

Systems and techniques are described herein for providing a load balancing between access points. For example, the systems and techniques can provide solutions for balancing the load between network devices, such as a primary access point and a secondary access point, to improve system performance (e.g., to improve radio access network (RAN) and ESL system performance). In one or more aspects, the systems and techniques can employ a management entity to coordinate with multiple network devices (e.g., access points) to manage connection requests for ACL links between the network devices to balance the load between the network devices.

In one or more examples, the management entity can offload connection requests from a primary access point to a secondary access point. For instance, the management entity, operating as a coordinator, can utilize two different approaches for offloading a connection request from a primary access point to a secondary access point. In one illustrative example, a first approach for offloading a connections request involves using a legacy connection mode to establish a BLE connection. In another illustrative example, a second approach for offloading a connections request involves using a fast connection mode to establish the BLE connection.

Additional aspects of the present disclosure are described in more detail below.

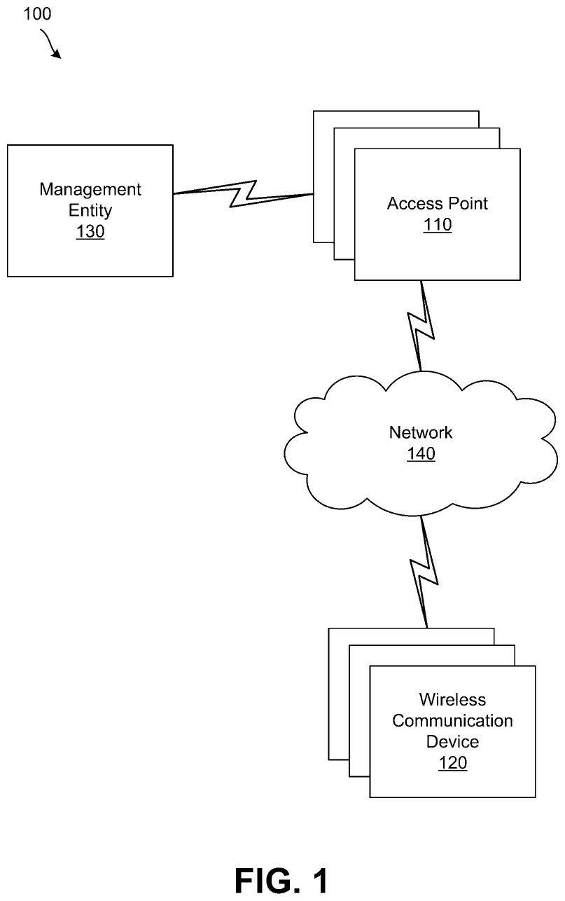

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

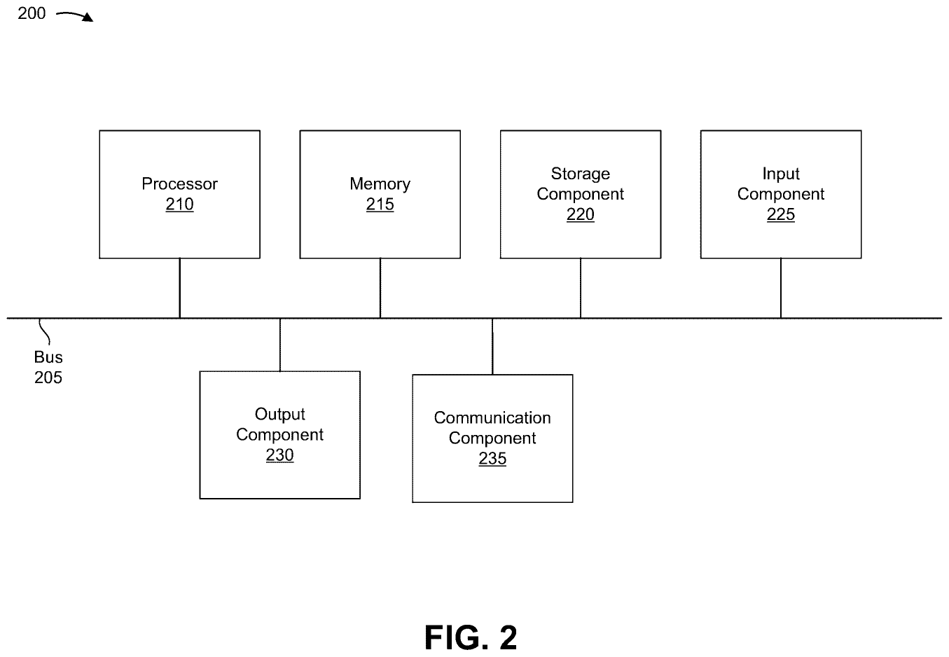

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™M network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

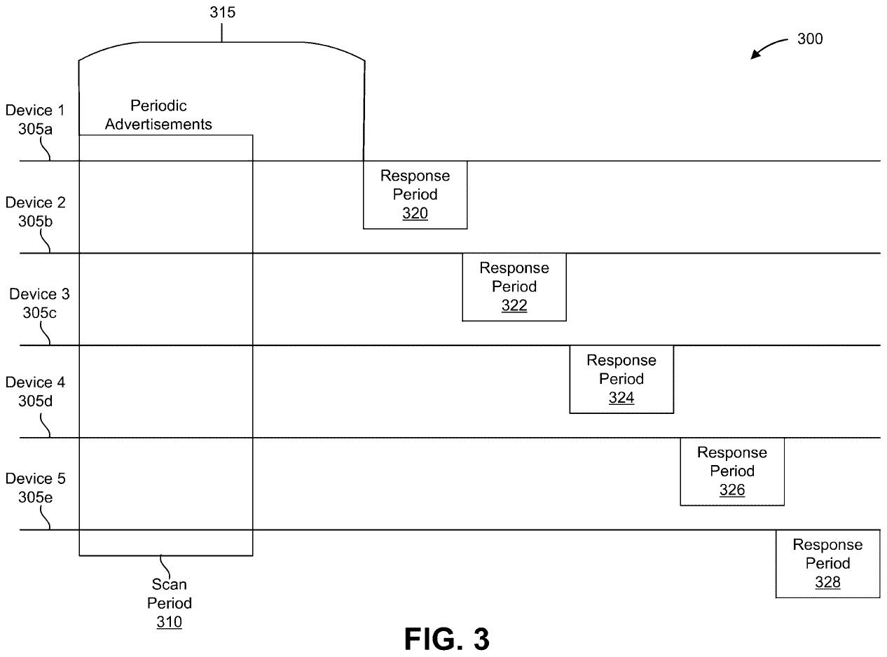

FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

FIG. 4 is a diagram illustrating an example of transmission timelines 400 associated with discovery and synchronization between access points (e.g., access points 110 of FIG. 1). As shown, example 300 includes access points (e.g., access points 110 of FIG. 1), shown as APᵢ 410 and APⱼ 420 on the transmission timelines 400. The access points APᵢ 410 and APⱼ 420 may be communicatively connected to a management entity (e.g., management entity 130 of FIG. 1). In some aspects, the access points and/or the management entity may be included in a wireless communication system, such as an ESL system. The wireless communication system may use a wireless communication technology, such as BLE.

As used herein, “transmission timing” or “periodic advertisement timing” may refer to a timing or schedule by which a device (e.g., an access point) transmits communications or periodic advertisements. For example, two devices that use (e.g., that are synchronized to) the same periodic advertisement timing may transmit periodic advertisements concurrently.

In one or more examples, during operation, a first access point AP1 (e.g., APᵢ 410) may transmit (e.g., broadcast) periodic advertisements (e.g., PAs 430a, 430b), such as a train of periodic advertisements. The periodic advertisements may be unidirectional broadcast messages. The first access point AP1 may transmit periodic advertisements in accordance with a PAwMR schedule. Moreover, the first access point AP1 may transmit the periodic advertisements using a first hopping frequency sequence (HFS) (or a frequency hop synchronization (FHS) in some cases). The first HFS may be an HFS configured for the first access point AP1 (e.g., if the first access point AP1 is not a follower of another access point), or the first HFS may be different from a reference HFS based at least in part on a first index value associated with (e.g., selected by) the first access point AP1.

A second access point AP2 (e.g., APⱼ 420) may detect at least one periodic advertisement broadcast from the first access point AP1 (e.g., by scanning known channels on which the first access point AP1 performs transmissions and/or by scanning, or taking a snapshot of, an entire band). That is, the second access point AP2 may discover the first access point AP1. In some aspects, the second access point AP2 may listen on one or more advertisement channels (e.g., legacy advertisement channels) to detect information that enables the second access point AP2 to follow and synchronize with the first access point AP1, thereby enabling the second access point AP2 to monitor for the periodic advertisement(s) (e.g., PAs 430a, 430b). In some aspects, the second access point AP2 may monitor for (e.g., listen for) and detect the periodic advertisement(s) prior to initiation of periodic advertisement transmissions by the second access point AP2 (which may be referred to as a “detect before proceed” policy). For example, in a boot sequence during starting (or re-starting) of the second access point AP2, the second access point AP2 may listen for periodic advertisements from other access points before starting periodic advertisement transmissions. In some aspects, access points (e.g., isolated access points), such as the second access point AP2, may periodically listen for periodic advertisements from neighboring access points.

Based on detecting a periodic advertisement from the first access point AP1, the second access point AP2 may transmit, and the first access point AP1 may receive, a message (e.g., an unsolicited message) to initiate a connection between the first access point AP1 and the second access point AP2. Following the connection, or as part of the connection procedure, the first access point AP1 may transmit, and the second access point AP2 may receive, a synchronization message. The synchronization message may identify the periodic advertisement timing (e.g., the PawMR schedule) used by the first access point AP1. For example, the synchronization message may include PAST information that indicates the periodic advertising timing used by the first access point AP1 (e.g., by indicating a time offset used by the first access point AP₁). In some cases, the PAST information may also include the values of all of the parameters required for HFS computation as well as the channel map. In addition, or alternatively, the synchronization message may identify the first HFS used by the first access point AP1. For example, the PAST information may also indicate a reference HFS used by the first access point AP1, and the first HFS may be the reference HFS or an HFS that is shifted (e.g., frequency shuffled) from the reference HFS. For example, if an HFS is shifted from a reference HFS, then at all frequency instances in a frequency sequence, a channel index of the HFS may be different from a channel index of the reference HFS. In some aspects, the synchronization message may identify the first HFS used by the first access point AP1 by indicating the first index value associated with the first access point AP1 (e.g., the first HFS may be determined using the first index value and the reference HFS). For example, the synchronization message may indicate a set of index values that includes the first index value and/or one or more additional index values, associated with additional access points, known to the first access point AP1. In some aspects, the set of index values may include an index value for the second access point AP2 that indicates an HFS to be used by the second access point AP2.

The exchange of periodic advertising timing information (e.g., the exchange of PAST information) may enable the second access point AP2 to synchronize with the first access point AP1. Accordingly, in the same manner, multiple additional access points may synchronize to the same periodic advertisement timing. For example, a third access point AP3 may also synchronize with the first access point AP1, and a fourth access point AP4 may synchronize with the third access point AP3, thereby resulting in the fourth access point AP4 being synchronized with the second access point AP2 by transitive synchronization. In this way, multiple access points may become time synchronized with each other.

As shown by reference number 455, based on receiving the synchronization message, the second access point AP2 may transmit periodic advertisements (e.g., PAS 440a, 440b), such as transmissions on a data channel, synchronized with the periodic advertisement timing (e.g., the PAwMR schedule) used by the first access point AP1. In this way, periodic advertisements are transmitted concurrently by the first access point AP1 and the second access point AP2. However, the second access point AP2 may transmit the periodic advertisements according to a second HFS. The second HFS may be offset from (e.g., different from) the first HFS used by the first access point AP1 or a reference HFS. In other words, each of the access points (e.g., with physically overlapping coverage areas) may use an HFS that is different from an HFS of any of the other access points. By using different HFSs, interference among the access points may be avoided despite the access points being time synchronized. As such, for any two HFSs of different APs, the probability of selecting the same channel at the same instant of time should be low.

The second HFS may be based at least in part on a second index value (e.g., different from the first index value) associated with the second access point AP2. For example, each of the access points (e.g., with physically overlapping coverage areas) may be associated with a different index value from any of the other access points. Accordingly, based at least in part on the set of index values identified to the second access point AP2, the second access point AP2 may select the second index value to achieve an HFS (e.g., in a radio frequency range of the second access point AP₂) that is orthogonal to every other HFS currently in use. In some aspects, the second HFS may be shifted relative to the first HFS or the reference HFS based at least in part on the second index value. For example, the second HFS may be determined according to Equation 1 below:

HFSᵢ=(HFS₀+indexᵢ) mod 37 (1)

where HFS₀ is the reference HFS, HFSᵢ is the HFS being determined, and indexᵢ is the index value used to determine the HFS. Equation 1 uses a value of 37 for the modulo operation because a BLE system uses 37 data channels. However, a different value for the modulo operation may be used (e.g., corresponding to a quantity of channels) in other systems.

In some aspects, an index value may indicate an HFS in a manner other than as described above. That is, an index value may be any means to identify a hopping frequency channel (or “channel selection”) sequence. For example, each access point and each wireless communication device may be configured with a set of HFSs, and an index value may map to a particular HFS of the set of HFSs. Thus, indication of a set of index values, as described herein, may refer to the indication of all active (e.g., in use) HFSs of the set of HFSs.

In some aspects, the first access point AP1 may transmit, and one or more wireless communication devices (e.g., wireless communication devices 120 of FIG. 1) may receive, information identifying the periodic advertisement timing (e.g., PAST information) used by the first access point AP1. For example, the first access point AP1 may transmit the information in connection with onboarding the wireless communication device(s) to the first access point AP1. In some aspects, the second access point AP2 may transmit, and one or more wireless communication devices (e.g., wireless communication devices 120) may receive, information identifying the periodic advertisement timing (e.g., PAST information) used by the second access point AP2. For example, the second access point AP2 may transmit the information to wireless communication devices already onboarded with the second access point AP2, or the second access point AP2 may cause the wireless communication devices to repeat an onboarding procedure with the second access point AP2 during which the information is transmitted.

In some aspects, the first access point AP1 may transmit (e.g., via broadcast), and one or more wireless communication devices (e.g., wireless communication devices 120 of FIG. 1) synchronized to the first access point AP1 may receive, information identifying a set of (e.g., one or more) index values indicating HFSs used by one or more access points. For example, the set of index values may include the first index value associated with the first access point AP1, the second index value associated with the second access point AP2, and/or one or more additional index values, associated with additional access points, known to the first access point AP1. Similarly, in some aspects, the second access point AP2 may transmit (e.g., via broadcast), and one or more wireless communication devices (e.g., wireless communication devices 120 of FIG. 1) synchronized to the second access point AP2 may receive, information identifying a set of (e.g., one or more) index values indicating HFSs used by one or more access points. For example, the one or more index values may include the first index value associated with the first access point AP1, the second index value associated with the second access point AP2, and/or one or more additional index values, associated with additional access points, known to the second access point AP2. In some aspects, the first access point AP1 and/or the first access point AP1 may receive, from the management entity, information indicating the index values that are in use (e.g., valid indexes) for one or more additional access points.

Over time (e.g., due to clock drift), the periodic advertisement timing used by the first access point AP1 and the second access point AP2 may become misaligned. As shown by reference number 450, the second access point AP2 may monitor (e.g., sporadically) for an additional periodic advertisement from the first access point AP1 in a monitoring opportunity. In other words, the second access point AP2 may sacrifice a periodic advertisement transmission (e.g., for a particular group of wireless communication devices) in order to monitor (e.g., listen) for the additional periodic advertisement from the first access point AP1. In some aspects, the monitoring opportunity, in which the second access point AP2 monitors for the additional periodic advertisement, may be based at least in part on an expected clock drift between the first access point AP1 and the second access point AP2. Based on a timing of the additional periodic advertisement, the periodic advertisement timing may be realigned between the first access point AP1 and the second access point AP2. For example, the second access point AP2 may realign with the periodic advertisement timing used by the first access point AP1 based at least in part on a timing of the additional periodic advertisement (e.g., based at least in part on a difference between the actual timing of the additional periodic advertisement and an expected timing of the additional periodic advertisement).

In some examples, an access point that uses a transmission timing or schedule (e.g., a periodic advertisement timing or schedule) that is followed by another access point may be referred to as a “leader access point,” and an access point that synchronizes its transmission timing or schedule to the transmission timing or schedule of another access point may be referred to as a “follower access point.” In some cases, an access point may be both a leader access point and a follower access point. For example, the transmission timing or schedule used by a first access point may be followed by a second access point, and a third access point may follow the transmission timing or schedule used by the second access point. Thus, in this example, the second access point is both a leader access point and a follower access point.

As indicated above, FIG. 4 is provided as an example. Other examples may differ from what is described with respect to FIG. 4.

As previously mentioned, in a well-deployed ESL system within an environment (e.g., a large retail store, a warehouse, etc.), a management entity may manage many access points, where each access point can manage a large number of ESLs (e.g., up to 7000 ESLs). Each management entity may have detailed information regarding each access point and each ESL deployed within the environment. During operation of the ESL system, the management entity can support a variety of different features including, but not limited to, a wake up of the ESLs, an onboarding of the ESLs, an accessing of the ESLs, a generic attribute profile (GATT) protocol for data transfer, and a “Bulk Transfer” of data with the ESLs.

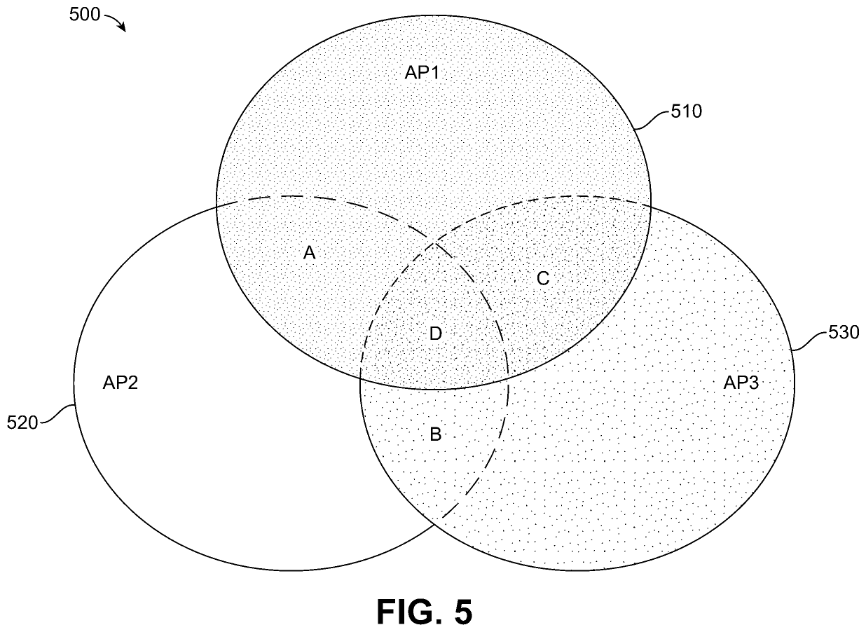

Each access point may be associated with a respective area (e.g., which denotes a signal range of that access point). FIG. 5 is a diagram 500 illustrating examples of areas 510, 520, 530 that are each associated with a respective AP (e.g., access points AP1, AP2, AP₂), where the areas overlap to form overlapping areas (e.g., overlapping areas A, B, C, D). In particular, in FIG. 5, access point AP1 is associated with area 510, access point AP2 is associated with area 520, and access point AP3 is associated with area 530.

ESLs located within an area can be managed by the access point associated with that area. For example, ESLs located within area 510 can be managed by AP1, ESLs located within area 520 can be managed by AP2, and ESLs located within area 530 can be managed by AP3.

ESLs located within an overlapping area can be managed by any access point associated with that overlapping area. For example, ESLs located within overlapping area A can be managed by access point AP1 or access point AP2, ESLs located within overlapping area B can be managed by access point AP2 or access point AP3, ESLs located within overlapping area C can be managed by access point AP1 or access point AP3, and ESLs located within overlapping area D can be managed by access point AP1, access point AP2, or access point AP3.

In one or more aspects, when an ESL is located within an overlapping area (e.g., overlapping area A, B, C, or D of FIG. 5), a connectable advertisement packet (CAP), which is an advert to initiate a connection, from the ESL can be reported to the management entity by the multiple access points associated with that overlapping area. The management entity can then choose one of those access points to be associated with that ESL. In one or more examples, the management entity can choose the access point based on a number of different factors including, but not limited to, the access point receiving a transmission advertisement packet (TAP) from that particular ESL, the access point having a strong received signal strength indication (RSSI) of the CAP and/or TAP, and/or the access point currently associated with the least number of ESLs. The decision of the management entity to assign the ESL to an access point is not necessarily based on the received signal strength of the CAP at that access point.

Once the ESL has onboarded onto the ESL system, the ESL can be associated with the chosen AP for that ESL. After the ESL is associated with the chosen AP, connection requests (e.g., GATT and/or Bulk Transfer requests) from the ESL can be pushed from the management entity to only that associated AP.

As previously mentioned, ESL systems can typically employ Asynchronous Connection-Oriented Links (ACLs), which are each a data link between an AP and an ESL for the transmission of general data packets over a BLE connection. Each AP within an ESL system, generally, can only have up to three concurrent ACLs. When an access point is running three ACLs, that access point is said to be experiencing a heavy loading and, as a result, that access point may not be able to handle any additional connection requests from a management entity (e.g., the access point may queue the connection requests), as previously described. As such, a load balancing between access points should be performed to increase the connection links capacity and to improve system performance.

In one or more aspects, the systems and techniques described herein provide a load balancing between access points. In one or more examples, the systems and techniques can provide solutions for balancing the load between access points, such as a primary access point and a secondary access point, to improve the RAN and ESL system performance. In one or more aspects, the systems and techniques can employ a management entity to coordinate with multiple access points to manage ACL links between access points to balance the load between access points.

In one or more aspects, for the systems and techniques, all of the access points should be synchronized with each other (e.g., by using the AP synchronization method described in the description of FIG. 4). The ESLs located within an overlapping area (e.g., overlapping area A, B, C, or D of FIG. 5) can be managed by a management entity via a primary access point. In one or more examples, for each ESL, a primary access point, a secondary access point and, optionally, a tertiary access point may be assigned to the ESL. The primary access point has a higher priority than the secondary access point, and the secondary access point has a higher priority than the tertiary access point. The management entity can share the primary access point information (and at least some secondary access point information) to each ESL during the onboarding procedure of the ESL. The management entity can update the priority of the access point listing (e.g., a list containing the primary access point, the secondary access point and, optionally, the tertiary access point assigned to the ESL) for each ESL, while asking the ESL to report the TAP with the RSSI. The ESLs may each have their assigned secondary access point's information, which may include a long term key (LTK) for a connection establishment between the secondary access point and the ESL. The management entity can offload connection requests (e.g., for GATT or “Bulk Transfer”) from a primary access point to a secondary access point. The ESLs can keep synchronization with the primary access point's periodic advertisement (PA) train.

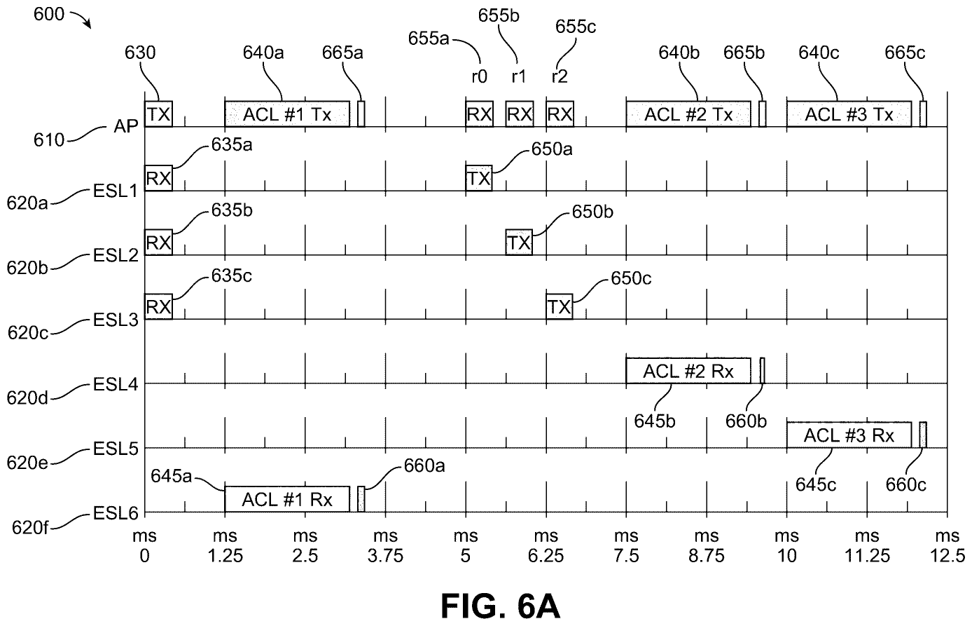

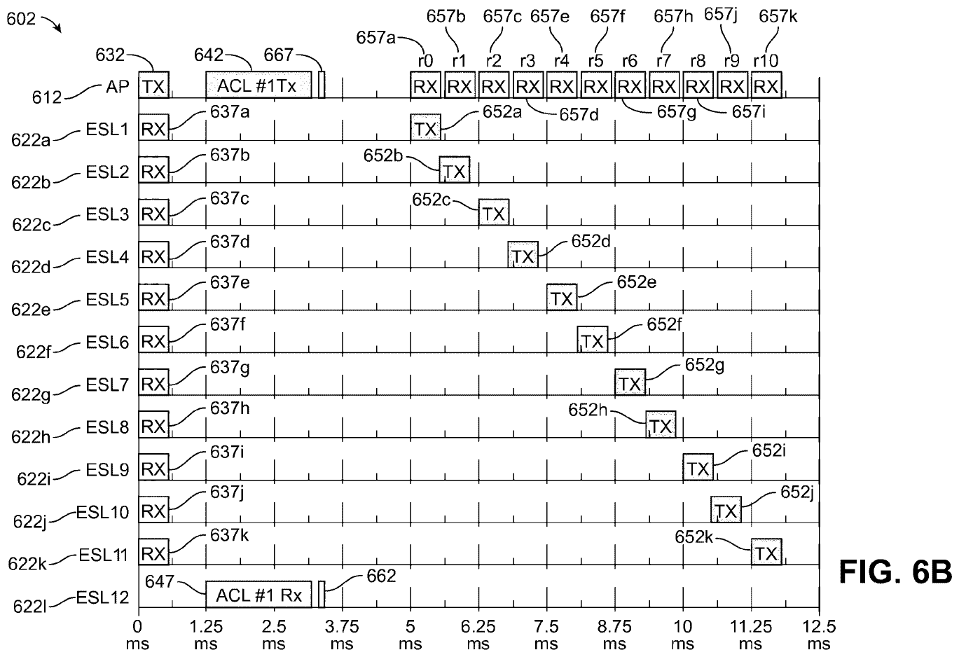

FIGS. 6A and 6B together show an example of a management entity balancing a load from a primary access point to a secondary access point. In particular, FIG. 6A is a diagram illustrating an example of an access protocol having three Asynchronous Connection-Oriented Link (ACL) (e.g., for a connection request or event) time slots (ACL1, ACL2, ACL3). In FIG. 6A, the diagram is shown in the form of a graph 600 with an x-axis denoting time in milliseconds (ms) and a y-axis denoting a primary access point 610 (e.g., a network device) and specific wireless communication devices (e.g., ESL1 620a, ESL 2620b , ESL 3 620c, ESL4 620d, ESL5 620e, and ESL6 620f). The wireless communication devices (e.g., ESL 1 620a, ESL 2620b , ESL 3 620c, ESL4 620d, ESL5 620e, and ESL6 620f) may be assigned to the primary access point 610. In particular, the x-axis of the graph of FIG. 6A denotes time starting from 0 ms and ending at 12.5 ms, which may represent a frame of time.

In FIG. 6A, during operation for PAwR, at time 0 ms, the primary access point 610 may transmit 630 to the wireless communication devices (e.g., ESL 1 620a, ESL 2 620b, ESL 3 620c, ESL4 620d, ESL5 620e, and ESL6 620f) a PA containing a synchronization message (e.g., an AP synchronization message) over a synchronized channel between the primary access point 610 and the wireless communication devices (e.g., ESL 1 620a, ESL 2620b , ESL 3 620c, ESL4 620d, ESL5 620e, and ESL6 620f). Also at time 0 ms, the wireless communication devices (e.g., ESL 1 620a, ESL 2620b , ESL 3 620c, ESL4 620d, ESL5 620e, and ESL6 620f) can receive 635a, 635b, 635c the PA containing the synchronization message over the synchronized channel.

In one or more examples, the primary access point 610 may be configured to transmit PAs at a specified time interval (e.g., a subframe of time), such as at every 12.5 ms as is shown in FIG. 6A. In one or more examples, the specified time interval (e.g., a subframe) may be shorter or longer than the 12.5 ms as is shown in FIG. 6A. The wireless communication devices (e.g., ESL 1 620a, ESL 2620b , ESL 3 620c, ESL4 620d, ESL5 620e, and ESL6 620f) may respond to a PA by using their specific respective response slot in time.

In one or more examples, the synchronization message transmitted 630 to the wireless communication devices (e.g., ESL 1 620a, ESL 2620b , ESL 3 620c, ESL4 620d, ESL5 620e, and ESL6 620f) may indicate a respective response slot for one or more of the wireless communication devices (e.g., ESL 1 620a, ESL 2620b , ESL 3 620c, ESL4 620d, ESL5 620e, and ESL6 620f) to use to transmit 650a, 650b, 650c a response to the primary access point 610. If a wireless communication device (e.g., ESL 1 620a, ESL 2 620b, ESL 3 620c, ESL4 620d, ESL5 620e, and ESL6 620f) is addressed within the synchronization message, the wireless communication device (e.g., ESL 1 620a, ESL 2 620b, ESL 3 620c, ESL4 620d, ESL5 620e, and ESL6 620f) can respond (e.g., transmit 650a, 650b, 650c) in its respective response slot, as indicated within the synchronization message. For example, the synchronization message may only address ESL 1 620a, ESL 2 620b, and ESL 3 620c and, as such, only ESL 1 620a, ESL 2620b , and ESL 3 620c will transmit 650a, 650b, 650c a response to the primary access point 610.

After the wireless communication devices (e.g., ESL 1 620a, ESL 2620b , ESL 3 620c, ESL4 620d, ESL5 620e, and ESL6 620f) have received 635a, 635b, 635c the PA (via transmission 630) containing the synchronization message from the primary access point 610, according to the sequence specified within the synchronization message, the one or more wireless communication devices (e.g., ESL 1 620a, ESL 2620b , and ESL 3 620c) can transmit 650a, 650b, 650c their responses within their respective response slots. After the one or more wireless communication devices (e.g., ESL 1 620a, ESL 2620b , and ESL 3 620c) have transmitted 650a, 650b, 650c their responses in their respective time slots, the primary access point 610 can receive 655a, 655b, 655c their transmitted responses at those specific response slot times.

Between the transmission 630 of the synchronization message by the primary access point 610 and the transmissions 650a, 650b, 650c of the responses from the one or more wireless communication devices (e.g., ESL 1 620a, ESL 2620b , and ESL 3 620c), the primary access point 610 can use a timeslot of an ACL1 link (shown as ACL #1 in FIG. 6A) to transmit 640a data to ESL6 620f. After ESL6 620f receives 645a the data in the timeslot of the ACL1 link, the ESL6 620f may transmit 660a data with an acknowledgement response (e.g., in a data header of a packet including the data) to the primary access point 610. The primary access point 610 may then receive 665a the data including the acknowledgment response from the ESL6 620f.

A second ACL link (ACL2) may be scheduled by the primary access point 610 after receiving 655a, 655b, 655c the transmissions 650a, 650b, 650c of the responses from the one or more wireless communication devices (e.g., ESL 1 620a, ESL 2620b , and ESL 3 620c). The primary access point 610 may use a timeslot of the ACL 2 link to transmit 640b data to ESL4 620d. After ESL4 620d receives 645b the data in the timeslot of the ACL2 link, the ESL4 620d may transmit 660b data with an acknowledgement response (e.g., in a data header of a packet including the data) to the primary access point 610. The primary access point 610 can then receive 665b the data including the acknowledgment response from the ESL4 620d.

After the second ACL link is scheduled by the primary access point 610, the primary access point 610 may schedule a third ACL link (ACL3). The primary access point 610 may use a timeslot of the ACL3 link to transmit 640c data to ESL5 620e. After ESL5 620e receives 645c the data in the timeslot of the ACL3 link, the ESL5 620e may transmit 660c data including an acknowledgement response (e.g., in a data header of a packet including the data) to the primary access point 610. Then, the primary access point 610 can receive 665c the data with the acknowledgment response from the ESL5 620e.

In FIG. 6A, since the primary access point 610 has three ACL link timing slots scheduled within its subframe, the primary access point 610 is not able to schedule another ACL link within this subframe of time, as discussed previously. Any new connection requests to any of the wireless communication devices (e.g., ESL 1 620a, ESL 2620b , ESL 3 620c, ESL4 620d, ESL5 620e, and ESL6 620f) from the primary access point 610 can be offloaded (e.g., transferred), by a management entity, to a secondary access point (e.g., secondary access point 612 of FIG. 6B) that has the available resources to schedule an ACL link. The secondary access point can then schedule the ACL link (e.g., connection request) and establish the connection with the ESL.

FIG. 6B is a diagram illustrating an example of an access protocol having one ACL (e.g., for a connection request or event) time slot (ACL1). In FIG. 6B, the diagram is shown in the form of a graph 602 with an x-axis denoting time in ms and a y-axis denoting a secondary access point 612 (e.g., a network device) and specific wireless communication devices (e.g., ESL 1622a , ESL 2622b , ESL 3 622c, ESL4 622d, ESL5 622e, ESL6 622f, ESL 7622g , ESL 8 622h, ESL 9 622i, ESL 10 622j, ESL 11 622k, and ESL 12 6221). The wireless communication devices (e.g., ESL1 622a to ESL 12 6221) may be assigned to the secondary access point 612. In particular, the x-axis of the graph of FIG. 6B denotes time starting from 0 ms and ending at 12.5 ms, which may represent a frame of time.

In FIG. 6B, during operation for PAwR, at time 0 ms, the secondary access point 612 may transmit 632 to the wireless communication devices (e.g., ESL1 622a to ESL12 6221) a PA containing a synchronization message (e.g., an AP synchronization message) over a synchronized channel between the secondary access point 612 and the wireless communication devices (e.g., ESL 1 622a to ESL12 6221). Also at time 0 ms, the wireless communication devices (e.g., ESL 1 622a to ESL 11 622k) can receive 637a, 637b, 637c, 637d, 637e, 637f, 637g, 637h, 637i, 637j, 637k the PA containing the synchronization message over the synchronized channel.

In one or more examples, the secondary access point 612 may be configured to transmit PAs at a specified time interval (e.g., a subframe of time), such as at every 12.5 ms as is shown in FIG. 6B. In one or more examples, the specified time interval (e.g., a subframe) may be shorter or longer than the 12.5 ms as is shown in FIG. 6B. The wireless communication devices (e.g., ESL 1 622a to ESL12 6221) may respond to a PA by using their specific respective response slot in time.

In one or more examples, the synchronization message transmitted 632 to the wireless communication devices (e.g., ESL 1 622a to ESL12 6221) may indicate a respective response slot for one or more of the wireless communication devices (e.g., ESL 1 622a to ESL 11 622k) to use to transmit 652a, 652b, 652c, 652d, 652e, 652f, 652g, 652h, 652i, 652j, 652k a response to the secondary access point 612. If a wireless communication device (e.g., ESL 1 622a to ESL 11 622k) is addressed within the synchronization message, the wireless communication device (e.g., ESL1 622a to ESL11 622k) can respond (e.g., transmit 652a to 652k) in its respective response slot, as indicated within the synchronization message. For example, the synchronization message may only address ESL 1 620a to ESL 11 622k, and, as such, only ESL 1 620a to ESL 11 622k will transmit 652a to 652k a response to the secondary access point 612.

After the wireless communication devices (e.g., ESL 1 622a to ESL 11 622k) have received 637a to 637k the PA containing the synchronization message from the secondary access point 612, according to the sequence specified within the synchronization message, the one or more wireless communication devices (e.g., ESL1 622a to ESL 11 622k) can transmit 652a to 652k their responses within their respective response slots. After the one or more wireless communication devices (e.g., ESL1 622a to ESL 11 622k) have transmitted 652a to 652k their responses in their respective time slots, the secondary access point 612 can receive 657a, 657b, 657c, 657d, 657e, 657f, 657g, 657h, 657i, 657j, 657k their transmitted responses at those specific response slot times.

Between the transmission 632 of the synchronization message by the secondary access point 612 and the transmissions 652a to 652k of the responses from the one or more wireless communication devices (e.g., ESL 1 622a to ESL 11 622k), the secondary access point 612 can use a timeslot of the ACL1 link to transmit 642 data to ESL12 6201. After ESL12 6201 receives 647 the data in the timeslot of the ACL 1 link, the ESL12 6201 may transmit 662 data including an acknowledgement response (e.g., in a data header of a packet including the data) to the secondary access point 612. The secondary access point 612 may then receive 667 the data including the acknowledgment response from the ESL12 6221.

In FIG. 6B, since the secondary access point 612 has only one ACL link timing slot scheduled within its subframe, the secondary access point 612 is able to schedule another ACL link within this subframe of time. As such, the management entity may offload (e.g., transfer) any new connection requests (e.g., GATT or “Bulk Transfer” requests) for the primary access point 610 to the secondary access point 612, which has the availability to be able to schedule another ACL link.

In one or more examples, the management entity may determine to offload connection requests for a primary access point to a secondary access point based on conditions other than the condition of the primary access point having a state of heaving loading (e.g., having 2 ACL links already scheduled). For example, the management entity may determine to offload connection requests for a primary access point to a secondary access point based on the fact that the management entity is aware that, in the future, there will be ESL with a higher priority than the other ESLs. For this case, the management entity may determine to offload connection requests for a primary access point to a secondary access point in order to keep one time slot open for an ACL for that ESL.

In one or more aspects, from an ESL point of view, the ESL should receive a synchronization message (e.g., AP_SYNC) from a primary access point. This AP_SYNC may conflict with a connection event (e.g., CONN_EVENT, such as within an ACL time slot) from a secondary access point, as the AP_SYNC is maintained via the primary access point and the CONN_EVENT is on the secondary access point. As such, if the primary access point and the secondary access point are not synchronized, the connection event to the second access point can potentially conflict with the PA (e.g., including the synchronization message) of the primary access point. In order to resolve any possible conflict, the access points (e.g., primary access point and secondary access point) should be synchronized (e.g., by using the AP synchronization method described in the description of FIG. 4). When the primary access point's PA and the secondary access point's PA have the same timing (e.g., the PAs are synchronized), the AP_SYNC from the primary access point should not conflict with the CONN_EVENT on the secondary access point.

In one or more aspects, the management entity, operating as a coordinator, may utilize two different approaches for offloading a connection request from a primary access point to a secondary access point. A first approach for offloading a connections request involves using a legacy connection mode to establish a BLE connection, and a second approach for offloading a connections request involves using a fast connection mode to establish the BLE connection. The legacy connection mode can establish a connection from a secondary access point via the ESL issuing a CAP. For the fast connection mode, the primary access point can transmit a synchronization packet or message (e.g., AP_SYNC) and an auxiliary (AUX) connection request packet or message (ACRQ), which can be denoted as AUX_CONNECT_REQ in some cases, and the second access point can transmit the first data to establish the connection with the ESL.

In one or more examples, for the legacy connection mode, during operation, the management entity can request a primary access point to send (e.g., transmit) to a target ESL a command (e.g., a start CAP operating code (OpCode)) in a synchronization message (AP_SYNC) to start the CAP. After the target ESL has received the command in the AP_SYNC, the ESL can start (e.g., broadcast) the CAP. Then, all access points, located nearby the ESL, can receive the CAP and report (e.g., transmit) the RSSI of the received CAP to the management entity. The management entity, operating as a coordinator, can identify a secondary access point for the connection offloading, and can request the secondary access point to handle connection requests (e.g., GATT and “Bulk Transfer” requests) to the ESL. Once connection with the ESL has been released by the secondary access point, the ESL can keep (e.g., maintain) synchronization with the primary access point.

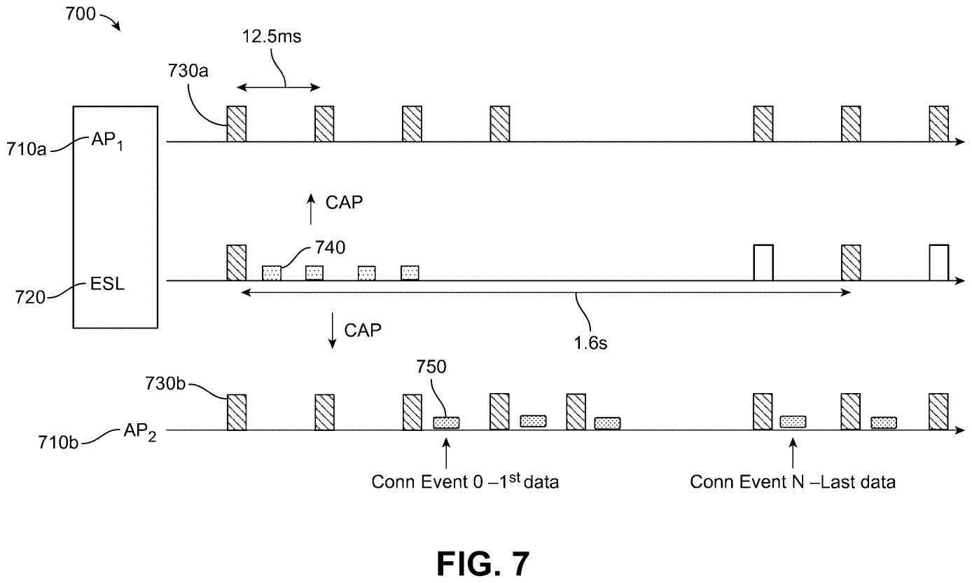

FIG. 7 is a diagram illustrating an example of access point offloading utilizing the first approach for offloading, which is the legacy connection mode (e.g., normal connection mode). In particular, FIG. 7 is a timing diagram 700 showing communication transmissions by a primary access point 710a (e.g., AP₁), an ESL 720, and a secondary access point 710b (e.g., AP₂). The primary access point 710a (e.g., AP₁) and the secondary access point 710b (e.g., AP₂) are synchronized with each other. The primary access point 710a (e.g., AP₁) and the secondary access point 710b (e.g., AP₂) can have the same synchronization message (e.g., AP_SYNC) timing for the ESL 720, and both the primary access point 710a (e.g., AP₁) and the secondary access point 710b (e.g., AP₂) can have the same pattern (e.g., PA train pattern) to schedule the ACL links (e.g., for the connection events). Since the primary access point 710a (e.g., AP₁) and the secondary access point 710b (e.g., AP₂) are synchronized, a connection event (e.g., CONN_EVENT) of the ESL 720 should not conflict with the synchronization message (e.g., AP_SYNC) from the primary access point 710a (e.g., AP₁). In some cases, the primary access point 710a (e.g., AP₁) has a higher priority than the secondary access point 710b (e.g., AP₂).

As shown in FIG. 7, the beacon (e.g., PA) timing for the primary access point 710a (e.g., AP₁), the ESL 720, and the secondary access point 710b (e.g., AP₂) is the same (e.g., is synchronized). The PA train 730a for the primary access point 710a (e.g., AP₁) is synchronized with the PA train 730b for the secondary access point 710b (e.g., AP₂).

During operation for the legacy connection mode, for the primary access point 710a (e.g., AP₁), the AP_SYNC in the PA 730a can include a command (e.g., a start CAP OpCode) to start the CAP. The ESL 720 is synchronized with the primary access point 710a (e.g., AP₁), and can receive the AP_SYNC with the command to start the CAP. After receiving the AP_SYNC with the command to start the CAP, the ESL 720 can start to transmit (e.g., broadcast) the CAP 740 to all nearby access points.

After the ESL 720 transmits (e.g., broadcasts) the CAP, the primary access point 710a (e.g., AP₁) and the secondary access point 710b (e.g., AP₂) can receive the CAP transmitted (e.g., broadcasted) from the ESL 720. After the secondary access point 710b (e.g., AP₂) receives the CAP, the secondary access point 710b (e.g., AP₂), which has availability to establish a connection (e.g., has availability for an ACL time slot), can transmit at least one connection event 750 (e.g., CONN_EVENT), which may be an example of a connection request, within an ACL time slot to try to establish a connection with the ESL 720.

As previously mentioned, the management entity, operating as a coordinator, may utilize two different approaches (e.g., a legacy connection mode, which was discussed in the description of FIG. 7, and a fast connection mode) for offloading a connection request from a primary access point to a secondary access point. In one or more examples, for the fast connection mode, during operation, a primary access point can send (e.g., transmit) to a target ESL an auxiliary (AUX) connection request packet (ACRQ) in a synchronization message (e.g., AP_SYNC), and attempt to receive an auxiliary connection request response packet (ACRP) transmitted in response from the target ESL. After receiving the ACRQ in the AP_SYNC from the primary access point, the target ESL can transmit an ESL response packet (ERP), which can include the ACRQ information, to a secondary access point. In one or more examples, the target ESL can transmit the ERP at various different time slots, such as 1.25 ms, 3.75 ms, 7.5 ms, and/or 10 ms slots.

The secondary access point can scan at the various different time slots (e.g., 1.25 ms, 3.75 ms, 7.5 ms, and/or 10 ms slots) to identify (e.g., receive) any offloaded ACRP information, which may be reported (e.g., transmitted) by the target ESL. After the secondary access point receives the ACRP information, the secondary access point can send (e.g., transmit) the data packet (e.g., CONN_EVENT) in a desired “transmitWindowOffset” (e.g., time slot) to the target ESL to establish a connection with the ESL. After the secondary access point has established a connection with the ESL, the secondary access point can report (e.g., transmit) to the management entity a message indicating that the connection event with the ESL has been completed (e.g., a connection event complete message). Once the connection is released between the ESL and the secondary access point, the ESL can keep (e.g., maintain) synchronization with the primary access point.

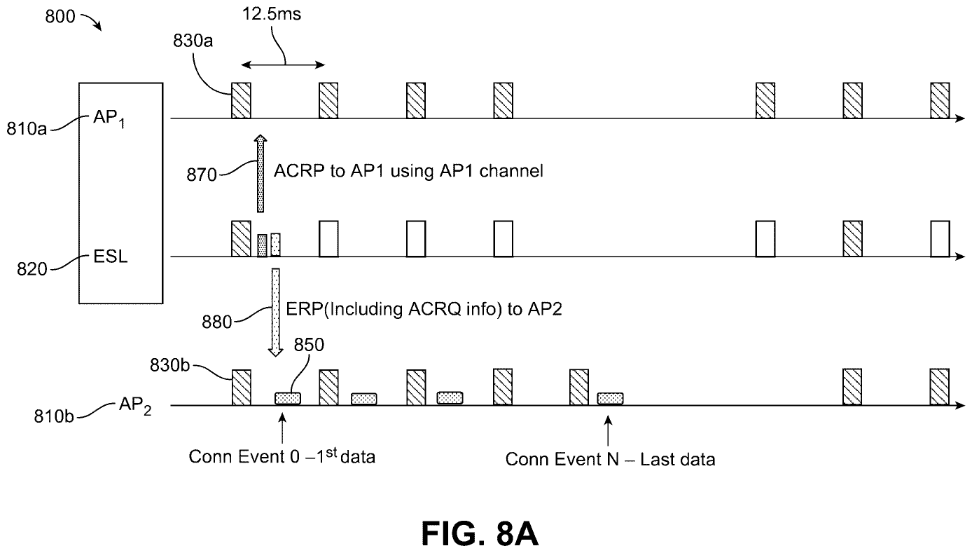

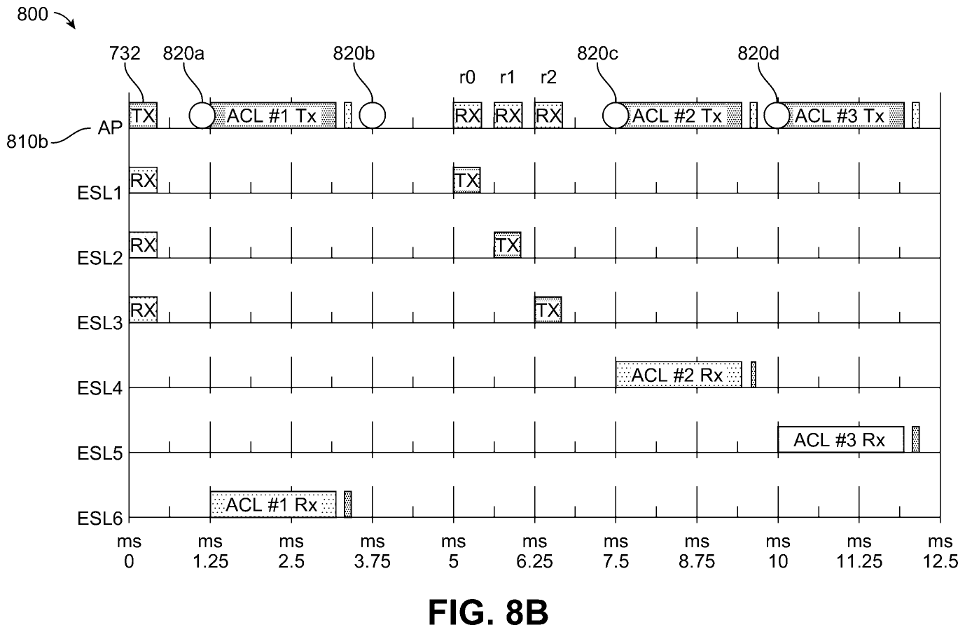

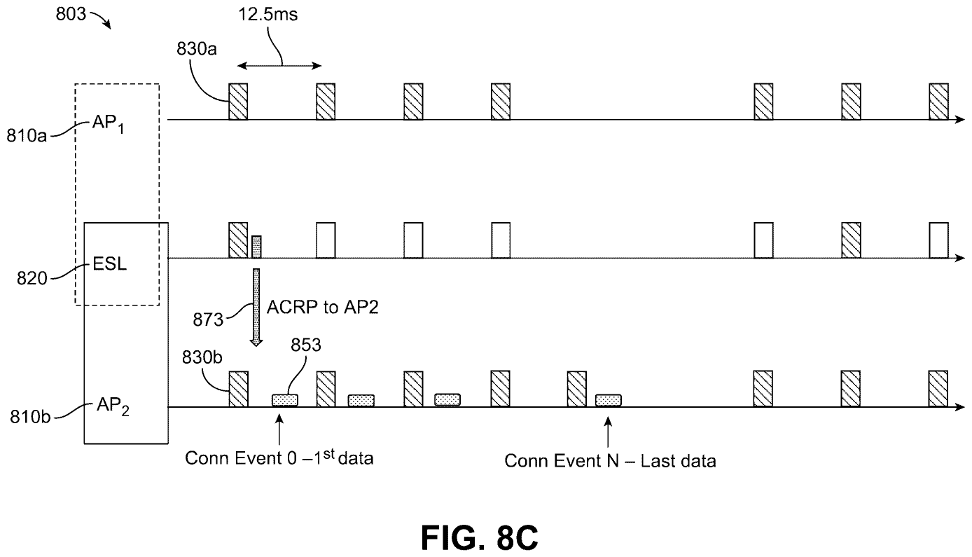

FIGS. 8A, 8B, and 8C illustrate examples showing access point offloading utilizing the second approach for offloading, which is the fast connection mode. In particular, FIG. 8A is a diagram illustrating an example of access point offloading utilizing the fast connection mode. In particular, FIG. 8A is a timing diagram 800 illustrating communication transmissions by a primary access point 810a (e.g., AP₁), an ESL 820, and a secondary access point 810b (e.g., AP₂). The primary access point 810a (e.g., AP₁) and the secondary access point 810b (e.g., AP₂) are synchronized. The primary access point 810a (e.g., AP₁) and the secondary access point 810b (e.g., AP₂) have the same AP_SYNC timing for the ESL 820. Both the primary access point 810a (e.g., AP₁) and the secondary access point 810b (e.g., AP₂) have the same pattern (e.g., PA train pattern) to schedule the ACL links (e.g., for the connection events). Since the primary access point 810a (e.g., AP₁) and the secondary access point 810b (e.g., AP₂) are synchronized, a connection event (e.g., CONN_EVENT) of the ESL 820 should not conflict with the synchronization message (e.g., AP_SYNC) from the primary access point 710a (e.g., AP₁).

As shown in FIG. 8A, the beacon (e.g., PA) timing for the primary access point 810a (e.g., AP₁), the ESL 820, and the secondary access point 810b (e.g., AP₂) is the same (e.g., is synchronized). The PA train 830a for the primary access point 810a (e.g., AP₁) is synchronized with the PA train 830b for the secondary access point 810b (e.g., AP₂).

During operation for the fast connection mode, for the primary access point 810a (e.g., AP₁), the AP_SYNC in the PA 830a can include an ACRQ. The ESL 820 is synchronized with the primary access point 810a (e.g., AP₁) and can receive the ACRQ in the AP SYNC. After receiving the ACRQ, the ESL 820 can respond by sending (e.g., transmitting) an ACRP 870 to the primary access point 810a (e.g., AP₁) within a primary access point channel.

The ESL 820 can also send (e.g., transmit) an ERP 880 (e.g., on a secondary network device channel), which includes the ACRP information, to the secondary access point 810b (e.g., AP₂) at different time slots (e.g., 1.25 ms, 3.75 ms, 7.5 ms, and/or 10 ms slots). The secondary access point 810b (e.g., AP₂) can scan at the different time slots (e.g., 1.25 ms, 3.75 ms, 7.5 ms, and/or 10 ms slots) to receive the ERP 880 from the ESL 820.

Once the secondary access point 810b (e.g., AP₂) has received the ERP 880 with the ACRQ information, the secondary access point 810b (e.g., AP₂) can send (e.g., transmit) the connection event (e.g., CONN_EVENT) 850 (e.g., a first data packet for a connection event) in the desired “transmitWindowOffset” (e.g., time slot) to the ESL 820 to establish a connection with the ESL 820. After the secondary access point 810b (e.g., AP₂) has established the connection with the ESL 820, the secondary access point 810b (e.g., AP₂) can send (e.g., transmit) to the management entity a message notifying the management entity that the connection with the ESL 820 has been completed. Once the connection between the secondary access point 810b (e.g., AP₂) and the ESL 820 has been released, the ESL 820 can keep (e.g., maintain) synchronization with the primary access point 810a (e.g., AP₁).

FIG. 8B is a diagram illustrating an example of an access protocol having three ACL time slots, where a secondary access point 810b (e.g., AP₂) is scanning for ACRQ information. In FIG. 8B, the diagram is shown in the form of a graph 802. The graph 802 of FIG. 8B is similar to (and operates similarly to) the graph 600 of FIG. 6A, except that the graph 802 of FIG. 8B additionally includes time slots 820a, 820b, 820c, 820d for the secondary access point 810b (e.g., AP₂) to perform scanning. In particular, the time slots 820a, 820b, 820c, 820d shown in FIG. 8B are indicative of when the secondary access point 810b (e.g., AP₂) scans for (e.g., to receive) the ERP 880 (e.g., which includes the ACRQ information) transmitted by the ESL 820.

FIG. 8C is a diagram illustrating an example of access point offloading utilizing a simplified fast connection mode. In particular, FIG. 8C is a timing diagram 803 illustrating communication transmissions by the primary access point 810a (e.g., AP₁), the ESL 820, and the secondary access point 810b (e.g., AP₂).

During operation for the simplified fast connection mode, the ESL 820 is initially synchronized with the primary access point 810a (e.g., AP₁). While attempting to offload a connection event from the primary access point 810a (e.g., AP₁) to the secondary access point 810b (e.g., AP₂), the management entity can temporarily synchronize the ESL 820 to the secondary access point 810b (e.g., AP₂).

For the secondary access point 810b (e.g., AP₂), the AP_SYNC in the PA 830b can include an ACRQ. The ESL 820 is now synchronized with the secondary access point 810b (e.g., AP₂) and can receive the ACRQ in the AP_SYNC. After receiving the ACRQ, the ESL 820 can respond by sending (e.g., transmitting) an ACRP 873 to the secondary access point 810b (e.g., AP₂) within a secondary access point channel.

Once the secondary access point 810b (e.g., AP₂) has received the ACRP 873 (e.g., containing ACRP information), the secondary access point 810b (e.g., AP₂) can send (e.g., transmit) the connection event (e.g., CONN_EVENT) 853 in the desired “transmitWindowOffset” (e.g., time slot) to the ESL 820 to establish a connection with the ESL 820. After the secondary access point 810b (e.g., AP₂) has established the connection with the ESL 820, the secondary access point 810b (e.g., AP₂) may send (e.g., transmit) to the management entity a message indicating that the connection with the ESL 820 has been completed. Once the connection between the secondary access point 810b (e.g., AP₂) and the ESL 820 has been released, the ESL 820 can keep (e.g., maintain) synchronization with the primary access point 810a (e.g., AP₁).

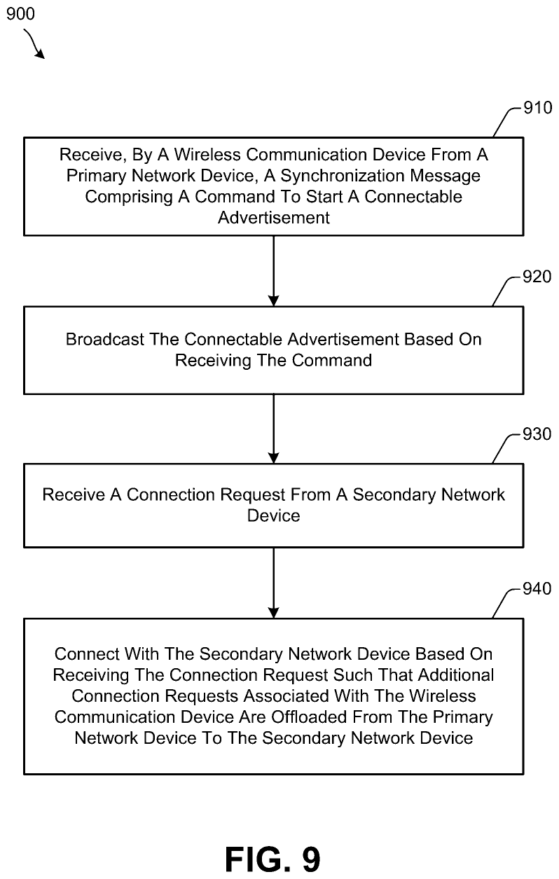

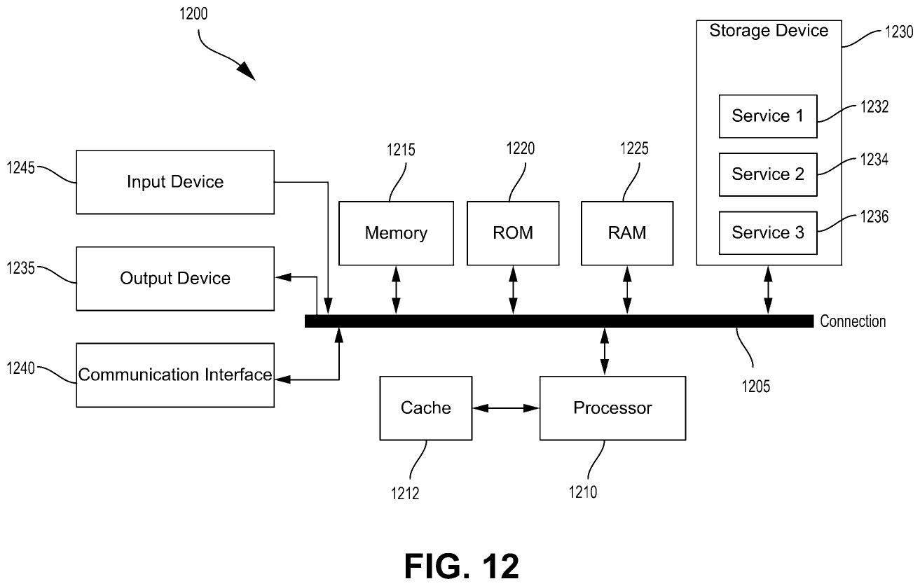

FIG. 9 is a flow chart illustrating an example of a process 900 for wireless communications utilizing methods for a legacy connection mode for load balancing between APs. The process 900 can be performed by a wireless communication device (e.g., wireless communication device 120 of FIG. 1, which may be in the form of an ESL) or by a component or system (e.g., a chipset) of the wireless communication device. The operations of the process 900 may be implemented as software components that are executed and run on one or more processors (e.g., processor 210 of FIG. 2, processor 1210 of FIG. 12, and/or other processor(s)). Further, the transmission and reception of signals by the wireless communications device in the process 900 may be enabled, for example, by one or more antennas and/or one or more transceivers such as one or more wireless transceivers (e.g., communication component 235 of FIG. 2, communication interface 1240 of FIG. 12, and/or other antenna(s) or transceiver(s)).

At block 910, the wireless communication device (or component thereof) can receive, from a primary network device, a synchronization message comprising a command to start a connectable advertisement. In some aspects, as described with respect to FIG. 7, the primary network device and the secondary network device are synchronized. For example, a periodic advertisement (PA) train of the primary network device and a PA train of the secondary network device are synchronized. In one illustrative example, the connectable advertisement is a connectable advertisement packet (CAP) (e.g., the CAP 740 of FIG. 7). In another illustrative example, the command is an operational code (OpCode) (e.g., the start CAP OpCode described with respect to FIG. 7).

At block 920, the wireless communication device (or component thereof) can broadcast the connectable advertisement based on receiving the command. In one illustrative example, as described above with respect to FIG. 7, after receiving the AP SYNC with the command to start the CAP, the ESL 720 can start to transmit (e.g., broadcast) the CAP 740 to access points with communication range of the ESL 720.

At block 930, the wireless communication device (or component thereof) can receive a connection request from a secondary network device. In some cases, the primary network device is a first access point (AP) (e.g., AP₁ 710a of FIG. 7) and the secondary network device is a second AP (e.g., AP₂ 710b of FIG. 7). In some cases, the connection request is within an Asynchronous Connection-Oriented Link (ACL) time slot. In some cases, with respect to the wireless communication device, the primary network device has a higher priority than the secondary network device.

At block 940, the wireless communication device (or component thereof) can connect with the secondary network device based on receiving the connection request such that additional connection requests associated with the wireless communication device are offloaded from the primary network device to the secondary network device. In some aspects, the additional connection requests are each one of a generic attribute profile (GATT) request for data transfer or a Bulk Transfer request for data.

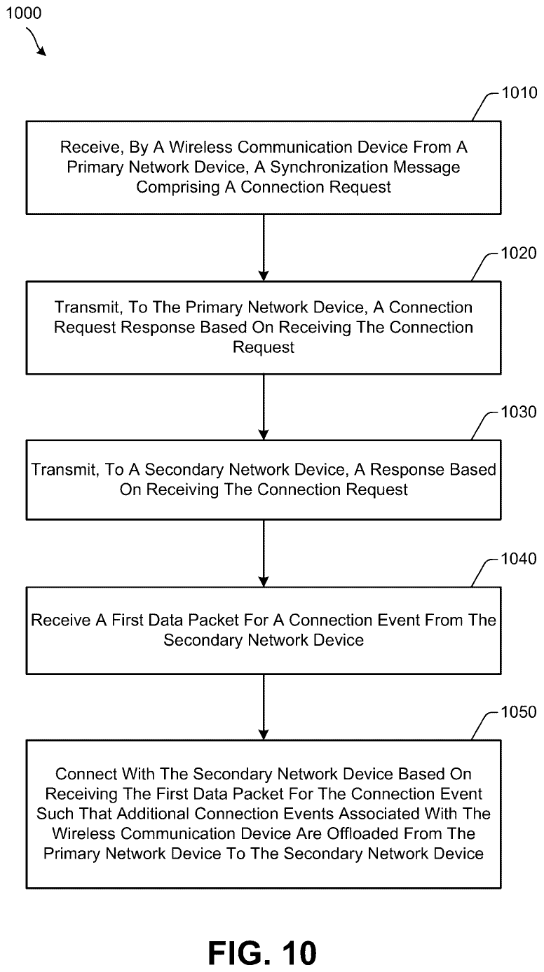

FIG. 10 is a flow chart illustrating an example of a process 1000 for wireless communications utilizing methods for a fast connection mode for load balancing between APs. The process 1000 can be performed by a (e.g., wireless communication device 120 of FIG. 1, which may be in the form of an ESL) or by a component or system (e.g., a chipset) of the wireless communication device. The operations of the process 1000 may be implemented as software components that are executed and run on one or more processors (e.g., processor 210 of FIG. 2, processor 1210 of FIG. 12, and/or other processor(s)). Further, the transmission and reception of signals by the wireless communications device in the process 1000 may be enabled, for example, by one or more antennas and/or one or more transceivers such as one or more wireless transceivers (e.g., communication component 235 of FIG. 2, communication interface 1240 of FIG. 12, and/or other antenna(s) or transceiver(s)).

At block 1010, the wireless communication device (or component thereof) can receive, from a primary network device, a synchronization message comprising a connection request. In some aspects, the connection request is an auxiliary connection request packet (ACRQ). In one illustrative example, as described with respect to FIG. 8A (e.g., during operation for the fast connection mode), the AP_SYNC in the PA 830a for the primary access point 810a (e.g., AP₁) can include an ACRQ. The ESL 820 is synchronized with the primary access point 810a (e.g., AP₁) and can receive the ACRQ in the AP SYNC.

At block 1020, the wireless communication device (or component thereof) can transmit, to the primary network device, a connection request response based on receiving the connection request. In some cases, the connection request response is an auxiliary connection request response packet (ACRP). In some aspects, the connection request response is transmitted on a primary network device channel. In one illustrative example, as described with respect to FIG. 8A, after receiving the ACRQ as noted above with respect to block 1010, the ESL 820 can respond by sending (e.g., transmitting) an ACRP 870 to the primary access point 810a (e.g., AP₁) within the primary access point channel.

At block 1030, the wireless communication device (or component thereof) can transmit, to a secondary network device, a response based on receiving the connection request. In some cases, the wireless communication device (or component thereof) can transmit the response on a secondary network device channel and/or on at least one specific time slot. In some aspects, the response is an electronic shelf label (ESL) response packet (ERP). In some examples, the response includes information of the connection request and/or response. For instance, as described with respect to FIG. 8A, the ESL 820 can send (e.g., transmit) an ERP 880 (including the ACRP and/or ACRQ information) to the secondary access point 810b (e.g., AP₂). The ESL 820 can send the ERP 880 at different time slots (e.g., 1.25 ms, 3.75 ms, 7.5 ms, and/or 10 ms slots). The secondary access point 810b (e.g., AP₂) can scan at the different time slots (e.g., 1.25 ms, 3.75 ms, 7.5 ms, and/or 10 ms slots) to receive the ERP 880 from the ESL 820.

At block 1040, the wireless communication device (or component thereof) can receive a first data packet for a connection event from the secondary network device.

At block 1050, the wireless communication device (or component thereof) can connect with the secondary network device based on receiving the first data packet for the connection event such that additional connection events associated with the wireless communication device are offloaded from the primary network device to the secondary network device.

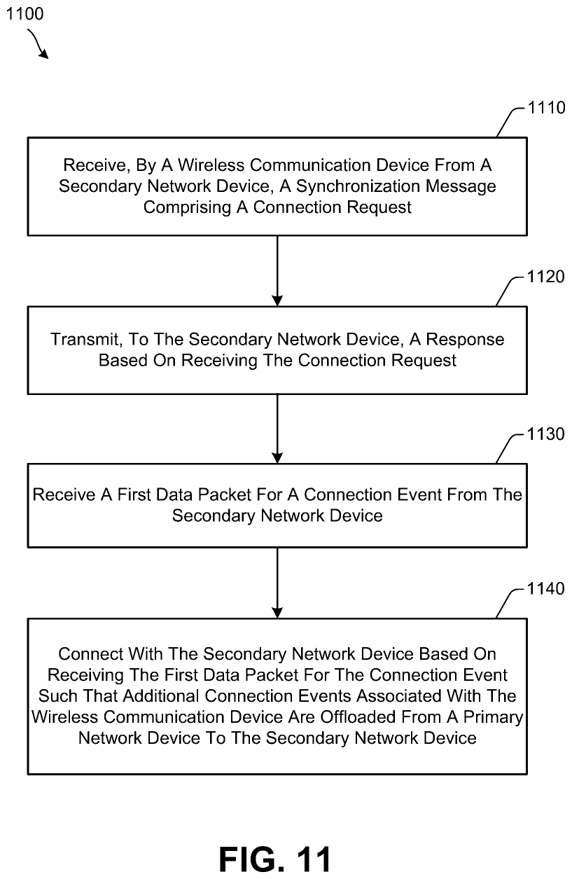

FIG. 11 is a flow chart illustrating an example of a process 1100 for wireless communications utilizing methods for a fast connection mode for load balancing between APs. The process 1100 can be performed by a (e.g., wireless communication device 120 of FIG. 1, which may be in the form of an ESL) or by a component or system (e.g., a chipset) of the wireless communication device. The operations of the process 1100 may be implemented as software components that are executed and run on one or more processors (e.g., processor 210 of FIG. 2, processor 1210 of FIG. 12, and/or other processor(s)). Further, the transmission and reception of signals by the wireless communications device in the process 1100 may be enabled, for example, by one or more antennas and/or one or more transceivers such as one or more wireless transceivers (e.g., communication component 235 of FIG. 2, communication interface 1240 of FIG. 12, and/or other antenna(s) or transceiver(s)).

At block 1110, the wireless communication device (or component thereof) can receive, from a secondary network device, a synchronization message comprising a connection request. In some aspects, the connection request is an auxiliary connection request packet (ACRQ). In one illustrative example, as described with respect to FIG. 8C, the AP SYNC in the PA 830b for the secondary access point 810b (e.g., AP₂) can include an ACRQ. In such an example, the ESL 820 is synchronized with the secondary access point 810b (e.g., AP₂) and can receive the ACRQ in the AP_SYNC.

At block 1120, the wireless communication device (or component thereof) can transmit, to the secondary network device, a response based on receiving the connection request. In some aspects, the response is an auxiliary connection request response packet (ACRP). In some aspects, the response is an electronic shelf label (ESL) response packet (ERP). In some cases, the response is transmitted on a secondary network device channel. In one illustrative example, as further described with respect to FIG. 8C, after receiving the ACRQ, the ESL 820 can respond by sending (e.g., transmitting) an ACRP 873 to the secondary access point 810b (e.g., AP₂) within a secondary access point channel.

At block 1130, the wireless communication device (or component thereof) can receive a first data packet for a connection event from the secondary network device. At block 1140, the wireless communication device (or component thereof) can connect with the secondary network device based on receiving the first data packet for the connection event such that additional connection events associated with the wireless communication device are offloaded from a primary network device to the secondary network device. In one illustrative example, as further described with respect to FIG. 8C, after the secondary access point 810b (e.g., AP₂) has received the ACRP 873 (e.g., containing ACRP information), the secondary access point 810b (e.g., AP₂) can send (e.g., transmit) the connection event (e.g., CONN_EVENT) 853 in the desired “transmitWindowOffset” (e.g., time slot) to the ESL 820 to establish a connection with the ESL 820. After the secondary access point 810b (e.g., AP₂) has established the connection with the ESL 820, the secondary access point 810b (e.g., AP₂) may send (e.g., transmit) to the management entity a message indicating that the connection with the ESL 820 has been completed. Once the connection between the secondary access point 810b (e.g., AP₂) and the ESL 820 has been released, the ESL 820 can keep (e.g., maintain) synchronization with the primary access point 810a (e.g., AP₁).

The network device (e.g., primary network device and/or secondary network device) may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

Components of the wireless communication device configured to perform the process 900 of FIG. 9, the process 1000 of FIG. 10, and/or the process 1100 of FIG. 11 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 900, the process 1000, and the process 1100 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 900, process 1000, the process 1100, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a block diagram illustrating an example of a computing system 1200, which may be employed by the disclosed systems and techniques for load balancing between APs. In particular, FIG. 12 illustrates an example of computing system 1200, which can be, for example, any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., LIDAR sensors, laser range finders, RF radars, ultrasonic sensors, and infrared (IR) sensors) configured to collect data and provide measurements to processor 1210, whereby processor 1210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of”′ a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:
Aspect 1. A wireless communication device for wireless communication, the wireless communication device comprising: at least one memory; and at least one processor coupled to the at least one memory and configured to: receive, from a primary network device, a synchronization message comprising a command to start a connectable advertisement; broadcast the connectable advertisement based on receiving the command; receive a connection request from a secondary network device; and connect with the secondary network device based on receiving the connection request such that additional connection requests associated with the wireless communication device are offloaded from the primary network device to the secondary network device.
Aspect 2. The wireless communication device of Aspect 1, wherein the primary network device and the secondary network device are synchronized.
Aspect 3. The wireless communication device of any one of Aspects 1 or 2, wherein a periodic advertisement (PA) train of the primary network device and a PA train of the secondary network device are synchronized.
Aspect 4. The wireless communication device of any one of Aspects 1 to 3, wherein the wireless communication device is an electronic shelf label (ESL).
Aspect 5. The wireless communication device of any one of Aspects 1 to 4, wherein the primary network device is a first access point (AP) and the secondary network device is a second AP.
Aspect 6. The wireless communication device of any one of Aspects 1 to 5, wherein the command is an operational code (OpCode).
Aspect 7. The wireless communication device of any one of Aspects 1 to 6, wherein the connectable advertisement is a connectable advertisement packet (CAP).
Aspect 8. The wireless communication device of any one of Aspects 1 to 7, wherein the connection request is within an Asynchronous Connection-Oriented Link (ACL) time slot.
Aspect 9. The wireless communication device of any one of Aspects 1 to 8, wherein the additional connection requests are each one of a generic attribute profile (GATT) request for data transfer or a Bulk Transfer request for data.
Aspect 10. The wireless communication device of any one of Aspects 1 to 9, wherein, with respect to the wireless communication device, the primary network device has a higher priority than the secondary network device.
Aspect 11. A wireless communication device for wireless communication, the wireless communication device comprising: at least one memory; and at least one processor coupled to the at least one memory and configured to: receive, from a primary network device, a synchronization message comprising a connection request; transmit, to the primary network device, a connection request response based on receiving the connection request; transmit, to a secondary network device, a response based on receiving the connection request; receive a first data packet for a connection event from the secondary network device; and connect with the secondary network device based on receiving the first data packet for the connection event such that additional connection events associated with the wireless communication device are offloaded from the primary network device to the secondary network device.
Aspect 12. The wireless communication device of Aspect 11, wherein the connection request is an auxiliary connection request packet (ACRQ).
Aspect 13. The wireless communication device of any one of Aspects 11 or 12, wherein the connection request response is an auxiliary connection request response packet (ACRP).
Aspect 14. The wireless communication device of any one of Aspects 11 to 13, wherein the response is an electronic shelf label (ESL) response packet (ERP).
Aspect 15. The wireless communication device of any one of Aspects 11 to 14, wherein the at least one processor is configured to transmit the response on a primary network device channel.
Aspect 16. The wireless communication device of any one of Aspects 11 to 15, wherein the at least one processor is configured to transmit the response on a secondary network device channel.
Aspect 17. The wireless communication device of any one of Aspects 11 to 16, wherein the response comprises information of the connection request.
Aspect 18. The wireless communication device of any one of Aspects 11 to 17, wherein the at least one processor is configured to transmit the response on at least one specific time slot.
Aspect 19. A wireless communication device for wireless communication, the wireless communication device comprising: at least one memory; and at least one processor coupled to the at least one memory and configured to: receive, from a secondary network device, a synchronization message comprising a connection request; transmit, to the secondary network device, a response based on receiving the connection request; receive a first data packet for a connection event from the secondary network device; and connect with the secondary network device based on receiving the first data packet for the connection event such that additional connection events associated with the wireless communication device are offloaded from a primary network device to the secondary network device.
Aspect 20. The wireless communication device of Aspect 19, wherein the connection request is an auxiliary connection request packet (ACRQ).
Aspect 21. The wireless communication device of any one of Aspects 19 or 20, wherein the response is an electronic shelf label (ESL) response packet (ERP).
Aspect 22. The wireless communication device of any one of Aspects 19 to 21, wherein the at least one processor is configured to transmit the response on a secondary network device channel.
Aspect 23. A method of wireless communication performed at a wireless communication device, the method comprising: receiving, by the wireless communication device from a primary network device, a synchronization message comprising a command to start a connectable advertisement; broadcasting, by the wireless communication device, the connectable advertisement based on receiving the command; receiving, by the wireless communication device, a connection request from a secondary network device; and connecting, by the wireless communication device, with the secondary network device based on receiving the connection request such that additional connection requests associated with the wireless communication device are offloaded from the primary network device to the secondary network device.
Aspect 24. The method of Aspect 23, wherein the primary network device and the secondary network device are synchronized.
Aspect 25. The method of any one of Aspects 23 or 24, wherein a periodic advertisement (PA) train of the primary network device and a PA train of the secondary network device are synchronized.
Aspect 26. The method of any one of Aspects 23 to 25, wherein the wireless communication device is an electronic shelf label (ESL).
Aspect 27. The method of any one of Aspects 23 to 26, the primary network device is a first access point (AP) and the secondary network device is a second AP.
Aspect 28. The method of any one of Aspects 23 to 27, wherein the command is an operational code (OpCode).
Aspect 29. The method of any one of Aspects 23 to 28, wherein the connectable advertisement is a connectable advertisement packet (CAP).
Aspect 30. The method of any one of Aspects 23 to 29, wherein the connection request is within an Asynchronous Connection-Oriented Link (ACL) time slot.
Aspect 31. The method of any one of Aspects 23 to 30, wherein the additional connection requests are each one of a generic attribute profile (GATT) request for data transfer or a Bulk Transfer request for data.
Aspect 32. The method of any one of Aspects 23 to 31, wherein, with respect to the wireless communication device, the primary network device has a higher priority than the secondary network device.
Aspect 33. A method of wireless communication performed at a wireless communication device, the method comprising: receiving, by the wireless communication device from a primary network device, a synchronization message comprising a connection request; transmitting, by the wireless communication device to the primary network device, a connection request response based on receiving the connection request; transmitting, by the wireless communication device to a secondary network device, a response based on receiving the connection request; receiving, by the wireless communication device, a first data packet for a connection event from the secondary network device; and connecting, by the wireless communication device, with the secondary network device based on receiving the first data packet for the connection event such that additional connection events associated with the wireless communication device are offloaded from the primary network device to the secondary network device.
Aspect 34. The method of Aspect 33, wherein the connection request is an auxiliary connection request packet (ACRQ).
Aspect 35. The method of any one of Aspects 33 or 34, wherein the connection request response is an auxiliary connection request response packet (ACRP).
Aspect 36. The method of any one of Aspects 33 to 35, wherein the response is an electronic shelf label (ESL) response packet (ERP).
Aspect 37. The method of any one of Aspects 33 to 36, wherein the connection request response is transmitted on a primary network device channel.
Aspect 38. The method of any one of Aspects 33 to 37, wherein the response is transmitted on a secondary network device channel.
Aspect 39. The method of any one of Aspects 33 to 38, wherein the response comprises information of the connection request.
Aspect 40. The method of any one of Aspects 33 to 39, wherein the response is transmitted on at least one specific time slot.
Aspect 41. A method of wireless communication performed at a wireless communication device, the method comprising: receiving, by the wireless communication device from a secondary network device, a synchronization message comprising a connection request; transmitting, by the wireless communication device to the secondary network device, a response based on receiving the connection request; receiving, by the wireless communication device, a first data packet for a connection event from the secondary network device; and connecting, by the wireless communication device, with the secondary network device based on receiving the first data packet for the connection event such that additional connection events associated with the wireless communication device are offloaded from a primary network device to the secondary network device.
Aspect 42. The method of Aspect 41, wherein the connection request is an auxiliary connection request packet (ACRQ).
Aspect 43. The method of any one of Aspects 41 or 42, wherein the response is an electronic shelf label (ESL) response packet (ERP).
Aspect 44. The method of any one of Aspects 41 to 43, wherein the response is transmitted on a secondary network device channel.
Aspect 45. A non-transitory computer-readable medium having stored thereon instructions that, when executed by at least one processor, cause the at least one processor to perform operation according to any of Aspects 23 to 32.
Aspect 46. An apparatus for wireless communications, comprising one or more means for performing operations according to any of Aspects 23 to 32.
Aspect 47. A non-transitory computer-readable medium having stored thereon instructions that, when executed by at least one processor, cause the at least one processor to perform operations according to any of Aspects 33 to 40.
Aspect 48. An apparatus for wireless communications, comprising one or more means for performing operations according to any of Aspects 33 to 40.
Aspect 49. A non-transitory computer-readable medium having stored thereon instructions that, when executed by at least one processor, cause the at least one processor to perform operations according to any of Aspects 41 to 44.
Aspect 50. An apparatus for wireless communications, comprising one or more means for performing operations according to any of Aspects 41 to 44.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A wireless communication device for wireless communication, the wireless communication device comprising:
at least one memory; and
at least one processor coupled to the at least one memory and configured to:
receive, from a primary network device, a synchronization message comprising a command to start a connectable advertisement;
broadcast the connectable advertisement based on receiving the command;
receive a connection request from a secondary network device; and
connect with the secondary network device based on receiving the connection request such that additional connection requests associated with the wireless communication device are offloaded from the primary network device to the secondary network device.

2. The wireless communication device of claim 1, wherein the primary network device and the secondary network device are synchronized.

3. The wireless communication device of claim 1, wherein a periodic advertisement (PA) train of the primary network device and a PA train of the secondary network device are synchronized.

4. The wireless communication device of claim 1, wherein the wireless communication device is an electronic shelf label (ESL).

5. The wireless communication device of claim 1, wherein the primary network device is a first access point (AP) and the secondary network device is a second AP.

6. The wireless communication device of claim 1, wherein the command is an operational code (OpCode).

7. The wireless communication device of claim 1, wherein the connectable advertisement is a connectable advertisement packet (CAP).

8. The wireless communication device of claim 1, wherein the connection request is within an Asynchronous Connection-Oriented Link (ACL) time slot.

9. The wireless communication device of claim 1, wherein the additional connection requests are each one of a generic attribute profile (GATT) request for data transfer or a Bulk Transfer request for data.

10. The wireless communication device of claim 1, wherein, with respect to the wireless communication device, the primary network device has a higher priority than the secondary network device.

11. A wireless communication device for wireless communication, the wireless communication device comprising:
at least one memory; and
at least one processor coupled to the at least one memory and configured to:
receive, from a primary network device, a synchronization message comprising a connection request;
transmit, to the primary network device, a connection request response based on receiving the connection request;
transmit, to a secondary network device, a response based on receiving the connection request;
receive a first data packet for a connection event from the secondary network device; and
connect with the secondary network device based on receiving the first data packet for the connection event such that additional connection events associated with the wireless communication device are offloaded from the primary network device to the secondary network device.

12. The wireless communication device of claim 11, wherein the connection request is an auxiliary connection request packet (ACRQ).

13. The wireless communication device of claim 11, wherein the connection request response is an auxiliary connection request response packet (ACRP).

14. The wireless communication device of claim 11, wherein the response is an electronic shelf label (ESL) response packet (ERP).

15. The wireless communication device of claim 11, wherein the at least one processor is configured to transmit the connection request response on a primary network device channel.

16. The wireless communication device of claim 11, wherein the at least one processor is configured to transmit the response on a secondary network device channel.

17. The wireless communication device of claim 11, wherein the response comprises information of the connection request.

18. The wireless communication device of claim 11, wherein the at least one processor is configured to transmit the response on at least one specific time slot.

19. A wireless communication device for wireless communication, the wireless communication device comprising:
at least one memory; and
at least one processor coupled to the at least one memory and configured to:
receive, from a secondary network device, a synchronization message comprising a connection request;
transmit, to the secondary network device, a response based on receiving the connection request;
receive a first data packet for a connection event from the secondary network device; and
connect with the secondary network device based on receiving the first data packet for the connection event such that additional connection events associated with the wireless communication device are offloaded from a primary network device to the secondary network device.

20. The wireless communication device of claim 19, wherein the connection request is an auxiliary connection request packet (ACRQ).

21-30. (canceled)
